(19) United States
(12) Patent Application Publication
(10) Pub. No.: US 2024/0379262 A1
(43) Pub. Date: Nov. 14, 2024

(54) CABLE ASSEMBLY

(71) Applicant: I-PEX Inc., Kyoto-shi, Kyoto (JP)

(72) Inventors: Masashi NAKAMURA, Ogori-city, Fukuoka (JP); Koji FUKUDOME, Ogori-city, Fukuoka (JP); Yohei TSUDA, Ogori-city, Fukuoka (JP)

(21) Appl. No.: 18/749,721

(22) Filed: Jun. 21, 2024

Related U.S. Application Data
(63) Continuation of application No. PCT/JP2022/046266, filed on Dec. 15, 2022.

(30) Foreign Application Priority Data
Dec. 28, 2021 (JP) 2021-213790

(51) Int. Cl. H01B 11/18; H01B 5/04; H01B 7/18; H01R 9/05; H01R 12/75

(52) U.S. Cl. CPC H01B 11/1895; H01B 5/04; H01B 7/18; H01R 9/0503; H01R 9/0512; H01R 12/75

(57) ABSTRACT

A cable assembly includes: a pair of transmission conductors; a dielectric covering the pair of transmission conductors; an outer conductor covering a surface of the dielectric; and a sheath covering the outer conductor, wherein the cable includes a first region, a second region, and a third region sequentially aligned from a tip of the cable, wherein in the first region, the pair of transmission conductors are exposed, wherein the second region includes: a connecting portion in which the outer conductor is exposed; and a non-connecting portion covered by the sheath, wherein in the third region, the outer conductor is covered with the sheath entirely over a circumference of the cable, wherein the connector includes: a pair of conductive contacts electrically connected to the pair of transmission conductors; and a conductive shell surrounding the pair of conductive contacts and electrically connected to the connecting portion.

### CROSS-REFERENCE TO RELATED APPLICATIONS

This application is a continuation application of PCT Application No. PCT/JP2022/046266, filed on Dec. 15, 2022, which claims the benefit of priority from Japanese Patent Application No. 2021-213790, filed on Dec. 28, 2021. The entire contents of the above listed PCT and priority applications are incorporated herein by reference.

### BACKGROUND

### Field

The present disclosure relates to a cable, a joint structure of a cable, and a joint structure of a cable and a connector.

### Description of the Related Art

As a differential signal cable, there is known a twinax cable in which two conductor wires are arranged and integrated by a shield serving as an outer conductor and further covered by an outer cover, as described in Japanese Unexamined Patent Publication No. 2016-192271. When such a twinax cable is connected to a connector or the like, operations in which a center conductor is exposed at a tip of the cable and a shield (outer conductor) provided at an outer periphery of the center conductor is exposed by peeling an outer cover are performed.

### SUMMARY

Disclosed herein is a cable assembly. The cable assembly may include: a pair of transmission conductors having conductivity; a dielectric covering the pair of transmission conductors; an outer conductor covering a surface of the dielectric; and a sheath covering the outer conductor, wherein the cable includes a first region, a second region, and a third region sequentially aligned from a tip of the cable, wherein in the first region, the sheath, the outer conductor, and the dielectric are removed and the pair of transmission conductors are exposed, wherein the second region includes: a connecting portion in which the sheath is removed and the outer conductor is exposed; and a non-connecting portion covered by the sheath, wherein in the third region, the outer conductor is covered with the sheath entirely over a circumference of the cable, wherein the connector includes: a pair of conductive contacts electrically connected to the pair of transmission conductors; and a conductive shell surrounding the pair of conductive contacts and electrically connected to the connecting portion.

Additionally, a cable is disclosed herein. The cable may include a pair of transmission conductors having conductivity; a dielectric covering the pair of transmission conductors; an outer conductor covering a surface of the dielectric; and a sheath covering the outer conductor, wherein the cable comprises a first region, a second region, and a third region sequentially aligned from a tip of the cable, wherein in the first region, the sheath, the outer conductor, and the dielectric are removed and the pair of transmission conductors are exposed, wherein the second region comprises: a connecting portion in which the sheath is removed and the outer conductor is exposed; and a non-connecting portion covered by the sheath, wherein in the third region, the outer conductor is covered with the sheath entirely over a circumference of the cable.

### BRIEF DESCRIPTION OF THE DRAWINGS

FIG. 1 is a diagram illustrating an example configuration of a connector system.

FIGS. 2A, 2B, and 2C are diagrams illustrating an example of a shape of a cable.

FIG. 3 is an example of an exploded perspective view of the connector system.

FIGS. 4A and 4B are diagrams illustrating an example state in which the cable is attached to a base unit.

FIGS. 5A and 5B are diagrams illustrating an example state in which the cable is attached to the base unit.

FIG. 6 is a diagram illustrating a method of assembling a second connector.

FIG. 7 is a diagram illustrating a method of assembling the second connector.

FIGS. 8A, 8B, and 8C are diagrams illustrating an example of a shape of a cable according to a first modification.

FIGS. 9A and 9B are diagrams illustrating an example of a state in which the cable is attached to the base unit.

FIGS. 10A, 10B, and 10C are diagrams illustrating an example of a shape of a cable according to a second modification.

FIGS. 11A and 11B are diagrams illustrating an example of a state in which the cable is attached to the base unit.

### DETAILED DESCRIPTION

In the following description, with reference to the drawings, the same reference numbers are assigned to the same components or to similar components having the same function, and overlapping description is omitted.

### Connector System

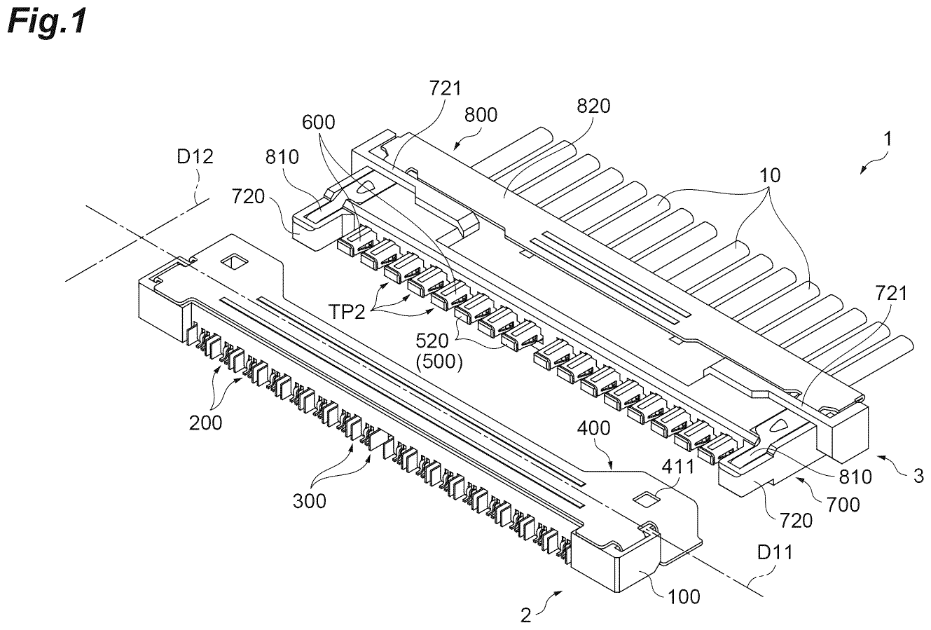

An example connector system 1 is illustrated in FIG. 1. The connector system 1 is used for connection between a circuit board (not illustrated) and a plurality of cables 10 in an application requiring transmission of a high-frequency signal with low deterioration and reduction in height. An example of such an application is an information processing system in which signals are transmitted on a circuit board by the plurality of cables 10 instead of printed wires on the circuit board. By forming each of the plurality of cables 10 as a shielded cable or the like, a signal may be transmitted with signal transmitting characteristics higher than those of the printed wires. The signal transmission characteristics mean a smallness of signal degradation in signal transmission, and high signal transmission characteristics means that the signal degradation in signal transmission is small. Examples of the signal deterioration include mixing of noise due to crosstalk or the like and attenuation of a signal.

The connector system 1 includes a first connector 2 and a second connector 3. The first connector 2 is, for example, a receptacle connector and is connected to the circuit board. The second connector 3 is, for example, a plug connector and is connected to the plurality of cables 10. The second connector 3 is connectable to the first connector 2. By connecting the second connector 3 to the first connector 2, the plurality of cables 10 are electrically connected to the circuit board (not illustrated) via the first connector 2. The first connector 2 and the second connector 3 may fit together along a fitting direction D12.

The first connector 2 includes a plurality of signal contacts 200, a plurality of shells 300, and a housing 100. The plurality of signal contacts 200 are aligned along an array orientation D11 parallel to the circuit board and perpendicular to the fitting direction D12. Each of the plurality of signal contacts 200 is electrically connected to the circuit board and is in contact with a signal contact of a mate connector (the second connector 3). Each of the plurality of shells 300 surrounds at least one signal contact 200 about an axis along the fitting direction D12 within the housing 100 that is not illustrated.

The plurality of signal contacts 200 transmit a plurality of types of signals. The plurality of shells 300 may be provided for each of the plurality of types of signals. In a region surrounded by each of the plurality of shells 300, one type of signal is transmitted and other signals are not transmitted. As an example, each of the plurality of signal contacts 200 may transmit one type of signal reference to a ground potential. The plurality of shells 300 are provided for each of the plurality of signal contacts 200. Each of the plurality of shells 300 surrounds one signal contact 200 and does not surround other signal contacts 200. The plurality of signal contacts 200 may include a plurality of pairs of signal contacts 200 that respectively transmit a plurality of types of differential signals. The plurality of shells 300 are provided for each of the plurality of pairs of signal contacts 200. Each of the plurality of shells 300 surrounds one pair of signal contacts 200 and does not surround other signal contacts 200.

The housing 100 integrally holds the plurality of signal contacts 200 and the plurality of shells 300. Further, the first connector 2 may further include a conductive outer shell 400 covering the housing 100.

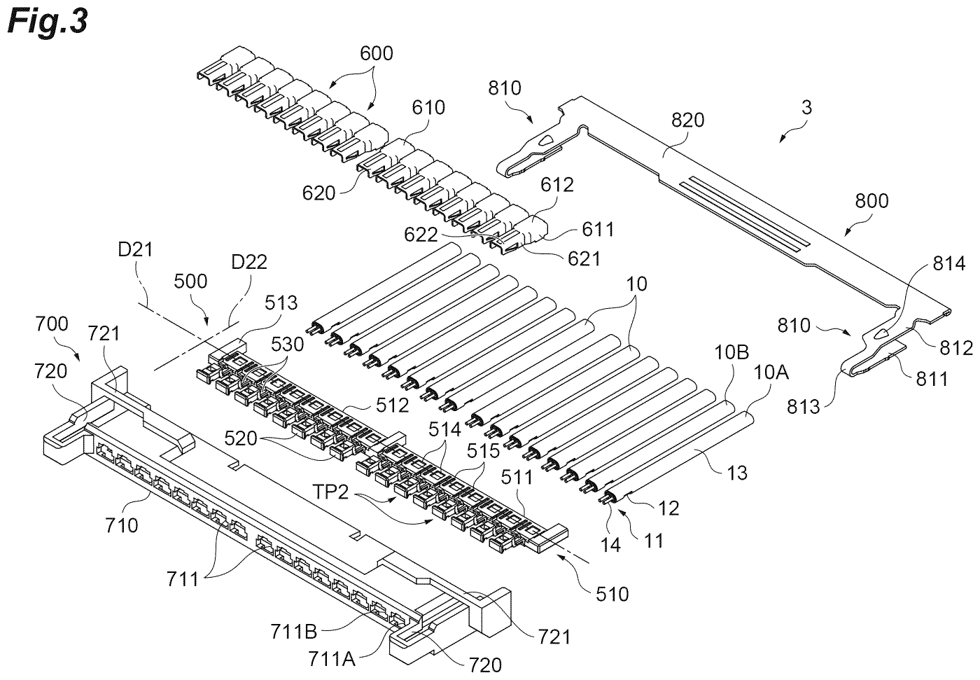

The second connector 3 includes a base unit 500 and a plurality of shells 600, as illustrated in FIG. 1. Further, as illustrated in FIG. 3, the base unit 500 includes a connector base 510, a plurality of insulating housings 520 (insulating sub housings), and a conductive signal contact 530. The connector base 510 extends along the array orientation D11 (D21). The plurality of housings 520 are arranged along the array orientation D11 and protrude from the connector base 510 in the same direction along the fitting direction D12 (D22).

The plurality of signal contacts 530 are held by the plurality of housings 520 so as to be arranged along the array orientation D11. Each of the plurality of signal contacts 530 is electrically connected to one of transmission conductors 14 in the plurality of cables 10 described later, and comes into contact with the signal contact 200 of a mate connector (the first connector 2). Each of the plurality of housings 520 holds at least one signal contact 530.

The plurality of signal contacts 530 may transmit the plurality of types of signals described above, and the plurality of housings 520 may be provided for each of the plurality of types of signals. In each of the plurality of housings 520, one type of signal is transmitted and other signals are not transmitted. As an example, each of the plurality of signal contacts 530 may transmit one type of signal referenced to the ground potential. The plurality of housings 520 are provided for each of the plurality of signal contacts 530. Each of the plurality of housings 520 holds one signal contact 530 and does not hold other signal contacts 530. The plurality of signal contacts 530 may include a plurality of pairs of signal contacts 530 that respectively transmit a plurality of types of differential signals. The plurality of housings 520 are provided for each of the plurality of pairs of signal contacts 530. Each of the plurality of housings 520 holds one pair of signal contacts 530 and does not hold other signal contacts 530.

The plurality of shells 600 correspond to the plurality of housings 520, respectively. Each of the plurality of shells 600 surrounds a corresponding housing 520 about an axis along the fitting direction D12 (D22).

The plurality of housings 520 correspond to the plurality of shells 300 of the first connector 2, respectively. Each of the plurality of housings 520 is inserted into a corresponding shell 300 along the fitting direction D12. Each of the plurality of shells 600 fits into a corresponding shell 300 along the fitting direction D12. Each of the plurality of signal contacts 530 contacts a corresponding signal contact 200 in a corresponding shell 300. Thus, the plurality of cables 10 are electrically connected to the circuit board.

In the above-described connector system 1, since the shape of the end portion of the cable 10 connected to the second connector 3 has above mentioned structure, deterioration of the transfer characteristics caused by change of the shape when the cable 10 is connected to the second connector 3 is prevented, and the characteristic impedance may be matched. An example of the cable 10 and the second connector 3 will be described in more detail below.

### Cable

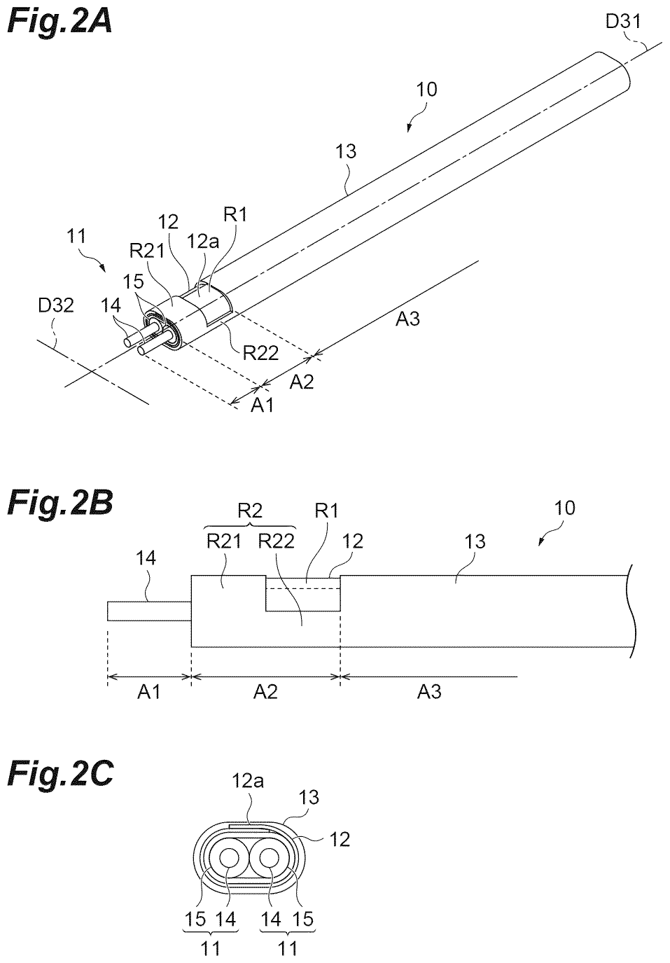

The cable 10 will be described with reference to FIGS. 2A, 2B, and 2C. As illustrated in FIGS. 2A and 2C and the like, the cable 10 includes a pair of electrics wires 11, an outer conductor 12, and an insulating sheath 13. Each of the pair of electric wire 11 includes one transmission conductor 14 and a dielectric 15 covering the transmission conductor 14. Hereinafter, the transmission conductors of the pair of electric wires 11 are referred to as a pair of transmission conductors 14. A differential signal is transmitted by the pair of transmission conductors 14. The outer conductor 12 surrounds the pair of electric wires 11 and the sheath 13 covers the outer conductor 12.

The pair of electric wires 11 is aligned along an array orientation D32 that is perpendicular to an axial orientation D31 of the cable 10. The array orientation D32 is in the same direction as the array orientations D11, D21.

The outer conductor 12 is composed of a plate-like member extending along the axial orientation D31 of the cable 10, and is in a state of being wound so as to integrally surround the periphery of the pair of electric wires 11 arranged in parallel, as illustrated in FIG. 2C. As a result, an overlapping portion 12a is formed in which the end portions of the outer conductor 12 overlap each other. The overlapping portion 12a extends along the axial orientation D31 of the cable 10, the end face of which is illustrated in FIG. 2C.

At the end portion of the cable 10, a part of the exterior is removed for joining with the second connector 3 described later. For example, as illustrated in FIGS. 2A and 2B, the cable 10 includes a first region A1, a second region A2, and a third region A3 arranged in order from the tip of the cable 10. The first region A1 is provided in a range of a first length from the tip. In the first region A1, the sheath 13, the outer conductor 12 and the dielectric 15 have been removed and the transmission conductor 14 is exposed. The length of the first region A1 is the first length. The second region A2 is provided at the inner end of the cable 10 with respect to the first region. The second region A2 is continuously provided on the first region A1 and the length of the second region A2 is a second length. The second region A2 includes a connecting portion R1 where the sheath 13 is removed and the outer conductor 12 is exposed and a non-connecting portion R2 covered by the sheath 13. The third region A3 is provided at the inner end of the cable 10 with respect to the second region A2. In the third region A3, the outer conductor 12 is covered with the sheath 13 over the entire circumference. The connecting portion R1 is adjacent to the third region A3. The “inner end” indicates a direction opposite to the direction toward the tip in the axial orientation of the cable.

In the cable 10 illustrated in FIGS. 2A, 2B, and 2C, the non-connecting portion R2 is adjacent to the first region A1. The non-connecting portion R2 of the second region A2 includes: an annular portion R21 that covers the entire circumference of the cable 10 at the boundary with the first region A1; and a coupling portion R22 that extends from the annular portion R21 along the axial orientation D31 of the cable 10 and is continuous with the sheath 13 provided at the inner end of the cable 10 with respect to the second region A2. For example, the annular portion R21 is adjacent to the first region A1 and extends around the entire circumference of the cable 10. The coupling portion R22 couples the annular portion R21 to the third region A3. Thus, the non-connecting portion R2 is as long as the second region A2 along the axial orientation D31. As illustrated in FIG. 2B, at the boundary between the annular portion R21 and the first region A1, the sheath 13 of the cable 10 surrounds the outer conductor 12 over the entire circumference. Accordingly, as illustrated in FIG. 2C, a part of the overlapping portion 12a (a part close to the boundary between the first region A1 and the second region A2) is covered by the sheath 13 in the second region A2. Thus, the movement of the overlapping portion 12a is restricted in the vicinity of the boundary between the first region A1 and the second region A2.

The connecting portion R1 is formed in a region of the second region A2 where the non-connecting portion R2 is not provided. For example, the connecting portion R1 is formed at an inner end of the cable 10 with respect to the annular portion R21 and at a position where the coupling portion R22 is provided. Further, as illustrated in FIGS. 2A and 2B, the connecting portion R1 is formed in the outer periphery of the cable 10 so as to open on one surface (the upper surface in FIG. 2B) of the surfaces extending along the array orientation D32 of the pair of electric wires 11. The connecting portion R1 may also be provided on a side surface of the cable 10 (an end portion of the cable 10 in the array orientation D32). The length along the axial orientation D31 of the connecting portion R1 is shorter than the length of the second region A2 and the same as the length of the coupling portion R22.

The length of the first region A1 and the length of the second region A2 in the cable 10 are set based on the relationship with the second connector 3. The location and size of the connecting portion R1 may also be adjusted based on the relationship with the second connector 3.

### Second Connector

The second connector 3 is connected to the plurality of cables 10.

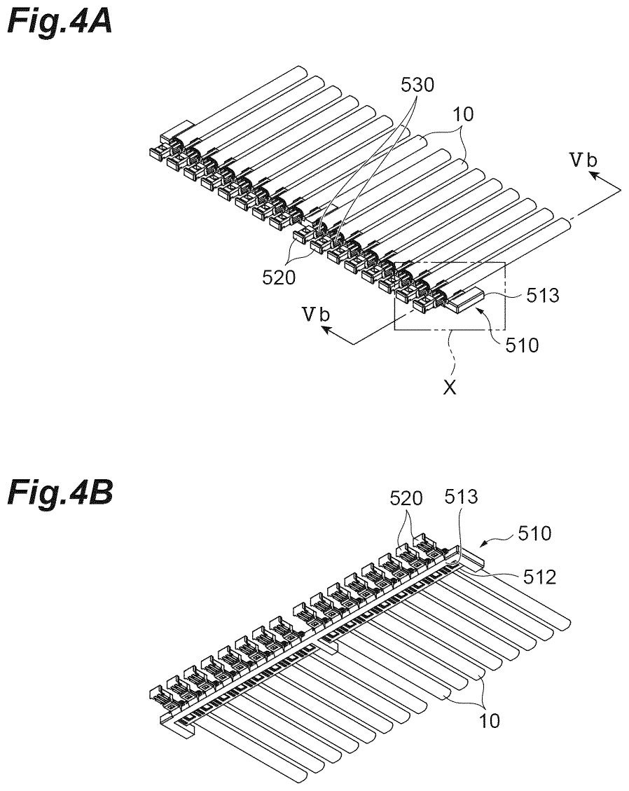

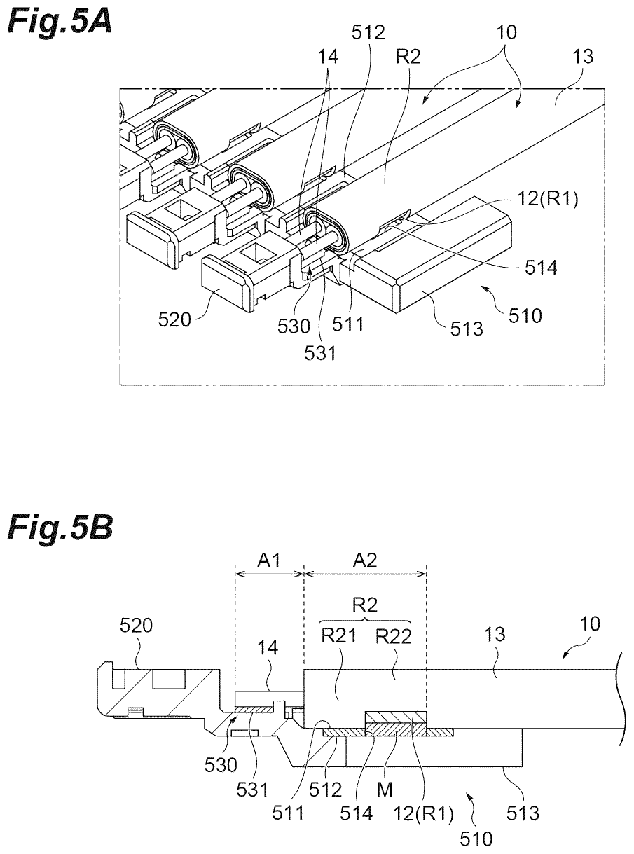

FIG. 3 is an exploded perspective view of the second connector 3, and FIGS. 4A and 4B and FIGS. 5A and 5B are views illustrating a state in which the cable 10 is attached to the base unit 500 illustrated in FIG. 3. FIGS. 4A and 4B are perspective views of the entire attachment portion of the base unit 500 and the cable 10, and FIG. 5A is a partially enlarged view of a region surrounded by a dashed line X in FIG. 4A. FIG. 5B is a cross-sectional view taken along line Vb-Vb illustrated in FIG. 4A.

As illustrated in FIG. 3, the second connector 3 includes the base unit 500 and the plurality of shells 600. As illustrated in FIGS. 4A and 4B, the base unit 500 includes the connector base 510, the plurality of insulating housings 520, and the plurality of conductive signal contacts 530.

The connector base 510 includes a facing surface 511. The facing surface 511 faces outer peripheries of end portions of the plurality of cables 10 arranged along the array orientation D21. The plurality of housings 520 correspond to the plurality of cables 10, respectively. The plurality of housings 520 are aligned along the array orientation D21 (see FIG. 3) and each project in a direction away from the end of the corresponding the cable 10 along a fitting direction D22 that is parallel to the facing surface 511 and perpendicular to the array orientation D21.

Hereinafter, for convenience of description, the direction in which the facing surface 511 faces is referred to as “upward”, and the opposite direction thereto is referred to as “downward”. Further, a direction in which the plurality of housings 520 protrude from the connector base 510 is referred to as “front”, and an opposite direction thereto is referred to as “rear”. According to these definitions, the plurality of cables 10 extend rearward from the connector base 510.

The plurality of signal contacts 530 include a plurality of pairs of signal contacts 530 respectively corresponding to the plurality of housings 520. Each of the plurality of pairs of signal contacts 530 is held in a corresponding housing 520. The above-described pair of transmission conductors 14 is connected to each of the plurality of pairs of signal contacts 530.

The plurality of shells 600 correspond to the plurality of housings 520, respectively. Each of the plurality of shells 600 surrounds a corresponding housing 520.

The second connector 3 includes a plurality of sets of signal transmission portions TP2 (see FIG. 1) respectively corresponding to the plurality of housings 520. The plurality of sets of signal transmission portions TP2 are arranged along the array orientation D21 and transmit the plurality of types of signals described above, respectively. Hereinafter, an example configuration of the first signal transmission portion TP2 from the right side in the drawing will be described in more detail as a representative of the plurality of sets of signal transmission portions TP2.

As illustrated in FIG. 3, the housing 520 constituting the signal transmission portion TP2 protrudes forward from the connector base 510 along the fitting direction D22.

The pair of signal contacts 530 are held by the housing 520 and connected to the pair of transmission conductors 14 of the cable 10, respectively. Each of the pair of signal contacts 530 includes a connecting portion 531 and a contact portion (not illustrated) arranged in order toward the front (see FIG. 5A).

The housing 520 holds the pair of signal contacts 530 so that the connecting portion 531 is exposed upward and the contact portion is exposed downward. This allows connecting the transmission conductor 14 to the connecting portion 531 from above. Further, the contact portion may come into contact with the signal contact 200 of the mate connector (the first connector 2) from above.

In the tip portion of the cable 10, a portion corresponding to the connecting portion 531 is defined as the first region A1. That is, the pair of transmission conductor 14 exposed by removing the sheath 13, the outer conductor 12, and the dielectric 15 are each connected to the connecting portion 531. The cable 10 is fixed relative to the base unit 500 with the connecting portion R1 of the second region A2 facing the base unit 500, that is, with the connecting portion R1 opening downwards.

The signal contact 530 is formed by, for example, punching and bending a metallic thin plate material.

As illustrated in FIG. 3, the shell 600 is fixed to the connector base 510 so as to surround the housing 520 about an axis along the fitting direction D22. For example, the shell 600 includes a base portion 610 and an end portion 620.

The base portion 610 surrounds the cable 10 and is fixed to the connector base 510. In the tip portion of the cable 10, a portion corresponding to the base portion 610 is the second region A2. The inner end of the second region A2 of the cable 10 may be partially covered with the base portion 610. At least the base portion 610 surrounds the second region A2 of the cable 10. The shape in which the base portion 610 surrounds the second region A2 is not particularly limited, and for example, the second region A2 may be surrounded in a circular shape, and the second region A2 may be surrounded in a polygonal shape. As an example, the base portion 610 may surround the second region A2 in a rectangular shape. For example, the base portion 610 includes a pair of base side walls 611 and a base coupling wall 612. The pair of base side walls 611 face each other along the array orientation D21. The outer conductor 12 of the cable 10 is located between the pair of base side walls 611 of the shell 600. The base coupling wall 612 extends parallel to the facing surface 511 and couples the pair of base side walls 611.

The end portion 620 extends forward from the base portion 610 along the fitting direction D22 and surrounds the housing 520. The shape surrounding the housing 520 is not particularly limited. The end portion 620 may surround the housing 520 in a circular shape or surround the housing 520 in a polygonal shape. As an example, the end portion 620 may surround the housing 520 in a rectangular shape. For example, the end portion 620 includes a pair of end side walls 621 and an end coupling wall 622. The pair of end side walls 621 are continuous with the pair of base side walls 611. The end coupling wall 622 is continuous with the base coupling wall 612 and couples the pair of end side walls 621.

Since the second region A2 of the cable 10 is located in the base portion 610, there is a part other than the transmission conductor 14, while the transmission conductor 14 of the cable 10 is present in the end portion 620. Accordingly, the width of the end portion 620 is smaller than the width of the base portion 610 along the array orientation D21 of the base portion 610.

The end portion 620 fits over the upper portion of the shell 300 of the first connector 2. For example, the pair of end side walls 621 respectively overlap with inner surfaces of a pair of side wall portions (not illustrated) of the shell 300, and the end coupling wall 622 portion overlaps with an inner surface of a facing wall portion (not illustrated). When the end portion 620 fits into the shell 300 in this manner, the surrounding of the housing 520 by the end portion 620 is supplemented by the shell 300. For example, the lower portion of the housing 520 that is not surrounded by the end portion 620 is surrounded by the shell 300. It is noted that the surrounding of the pair of signal contacts 200 by the shell 300 may be supplemented by the end portion 620.

Each of the pair of end side walls 621 may have an elastic contact portion. The elastic contact portion may move toward the housing 520 upon application of an external force and move away from the housing 520 upon removal of the external force. Since the elastic contact portions of the pair of end side walls 621 come into contact with the inner surfaces of the pair of side walls provided in the shell 300, the surrounding of the housing 520 by the end portion 620 is more firmly complemented by the shell 300.

The connector base 510 may include a conductive base plate 512 (a ground bar) and an insulating base housing 513. The base housing 513 holds the base plate 512 and the plurality of housings 520 (see FIG. 4B). The base unit 500 is formed by molding the base housing 513 and the plurality of housings 520 with a resinous material by insert molding performed in a state where the base plate 512 and the plurality of signal contacts 530 are arranged, or the like.

Returning to FIG. 3, the base plate 512 may have a plurality of fixing holes 514 each corresponding to the plurality of cables 10. The plurality of fixing holes 514 are arranged along the array orientation D11 and extend through the base plate 512 along a vertical orientation perpendicular to the facing surface 511. Each of the plurality of fixing holes 514 exposes the outer conductor 12 of the connecting portion R1 of the corresponding the cable 10, that is, an area from which the sheath 13 is removed.

The pair of base side walls 611 and the base coupling wall 612 of the base portion 610 of the shell 600 and the base plate 512 surround the second region A2 of the cable 10 (and a portion inside the second region A2), and the plurality of shells 600 are fixed to the base plate 512. The base plate 512 electrically connects the base portions 610 of the plurality of shells 600.

In the base portion 610 of the shell 600, the second region A2 of the cable 10 comes into contact with the base plate 512. At this time, the sheath 13 of the annular portion R21, which is the non-connecting portion R2 of the second region A2, comes into contact with the base plate 512, and the sheath 13 of the inner end of the connecting portion R1 may come into contact with the base plate 512.

In this state, the outer conductor 12 of the cable 10 is fixed to the base plate 512 by, for example, soldering. That is, as illustrated in FIG. 5B, the solder is supplied to the connecting portion R1 via the fixing hole 514. In this state, for example, the outer conductor 12 and the base plate 512 are fixed by melted a solder M by soldering or the like, and the outer conductor 12 and the base plate 512 are electrically connected.

Instead of electrically connecting the outer conductor 12 and the base plate 512 via the solder M that is melted, for example, the shape of the base plate 512 may be modified to increase the contact with the outer conductor 12. As such an example, for example, a protrusion (not illustrated) continuously extending from the base plate 512 to the inside of the fixing hole 514 and protruding toward the outer conductor 12 may be provided, and the base plate 512 and the outer conductor 12 may be brought into contact with each other via the protrusion. In such a configuration, by fixing them with the solder M as described above, the outer conductor 12 and the base plate 512 may be more firmly connected to each other via the convex portion. The protrusion may have elasticity so as to be deformed by contact with the outer conductor 12.

Since each of the plurality of shells 600 includes a pair of base side walls 611, the second connector 3 include a plurality of pairs of base side walls 611 arranged along the array orientation D21. Correspondingly, the base plate 512 may include a plurality of pairs of shell fixing holes 515 corresponding to the plurality of pairs of base side walls 611, respectively.

The plurality of fixing holes 514 and the plurality of pairs of shell fixing holes 515 are arranged along the array orientation D21. In this arrangement, one fixing hole 514 may be disposed between each of the plurality of pairs of shell fixing holes 515. Each of the plurality of pairs of shell fixing holes 515 extends through the base plate 512 along the vertical orientation and exposes the corresponding pair of base side walls 611 downward. As a result, the plurality of pairs of base side walls 611 and the outer conductors 12 in the connecting portions R1 of the plurality of cables 10 are exposed downward in a state of being lined up in a row. Accordingly, the plurality of pairs of base side walls 611 and the outer conductors 12 in the connecting portions R1 of the plurality of cables 10 may be collectively fixed to the base plate 512 by soldering or the like from below.

Each of the plurality of pairs of base side walls 611 may include a fixing piece inserted into a corresponding shell fixing hole 515. Thus, since the plurality of shells 600 may be positioned and temporarily fixed to the base plate 512 before fixing by soldering or the like, the workability when fixing the plurality of pairs of base side walls 611 and the outer conductors 12 of the plurality of cables 10 to the base plate 512 is improved. The fixing piece may be fixed to the base plate 512 by soldering or the like in a state of being inserted into the corresponding shell fixing hole 515.

Returning to FIG. 3, the second connector 3 may further include an insulating outer housing 700. The outer housing 700 accommodates the connector base 510 to which the plurality of shells 600 are fixed. The outer housing 700 may include a front wall 710 perpendicular to the fitting direction D22. The front wall 710 may include a plurality of openings 711 each corresponding to the plurality of housings 520. Each of the plurality of housings 520 protrudes forward from the outer housing 700 via a corresponding opening 711 while being surrounded by the shell 600.

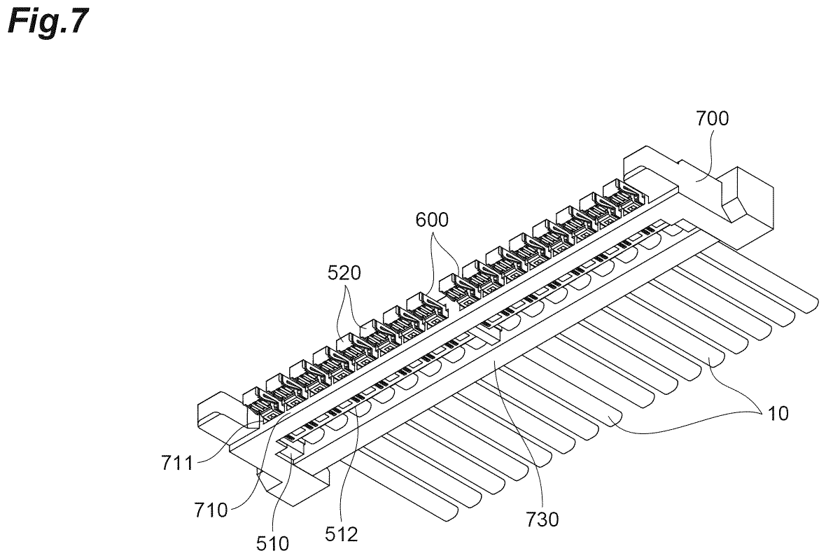

As illustrated in FIG. 7, the second connector 3 may further include an insulating separator 730 that is fixed to the outer housing 700 and regulates the interval between adjacent cables 10. The separator 730 holds the plurality of cables 10 from outside the sheath 13 behind the connector base 510. The connector base 510 is disposed between the front wall 710 and the separator 730. The separator 730 may include a plurality of openings arranged along the array orientation D21, each corresponding to the plurality of cables 10. Each of the plurality of openings extends through the separator 730 along the fitting direction D22. At this time, each of the plurality of cables 10 may be held in a corresponding opening. With the separator 730, a distance between the cables 10 may be maintained, and signal transfer characteristics may be further improved. The separator 730 may also increase the strength of fixation of the plurality of cables 10 to the second connector 3.

The separator 730 may be formed by two-color molding of resin performed in a state where the base unit 500, the plurality of shells 600 and the outer housing 700 are attached to the ends of the plurality of cables 10. The separator 730 may be formed by resin-sealing through potting. The base unit 500, the shell 600 and the outer housing 700 may be attached to the end of the plurality of cables 10 in a state where the pre-formed separator 730 is attached to the plurality of cables 10. The separator 730 may be formed separately into an upper member and a lower member, and the upper member and the lower member may be combined so as to sandwich the plurality of cables 10. The separator 730 may be attached to the base unit 500 or may be integrally molded with the base unit 500. Accordingly, the fixing strength of the plurality of cables 10 to the second connector 3 may further be increased.

The second connector 3 may further include a lock member 800. The lock member 800 prevents removal of the second connector 3 fitted to the first connector 2. The lock member 800 includes a pair of lock portions 810 and a lock knob 820. The pair of lock portions 810 is held by the outer housing 700 so as to respectively correspond to the plurality of lock openings 411 (see FIG. 1) provided in the first connector 2. The outer housing 700 further includes a pair of lock accommodating portions 720 opening upward and backward and a pair of hold bars 721 respectively corresponding to the pair of lock accommodating portions 720 at both ends of the array orientation D11, and the pair of lock portions 810 are respectively accommodated in the pair of lock accommodating portions 720. Each of the pair of hold bars 721 is located above the rear end of the corresponding lock accommodating portion 720 and holds the lock portion 810 in the lock accommodating portion 720 (see FIG. 1).

As illustrated in FIG. 3, each of the pair of lock portions 810 includes a lock base 811, a lock plate 812, and an elastic coupling portion 813. The lock base 811 extends along the fitting direction D22 and contacts the bottom surface of the lock accommodating portion 720. The lock plate 812 extends along the fitting direction D22 at a position apart from the bottom surface of the lock accommodating portion 720 and faces the lock base 811 in the vertical orientation. A lock claw 814 that is configured to engage the lock opening 411 of the first connector 2 is formed on the upper surface of the lock plate 812. The elastic coupling portion 813 couples the front end portion of the lock base 811 and the front end portion of the lock plate 812 so as to allow the lock claw 814 to be elastically displaced along the vertical orientation.

The lock portion 810 may switch a locked state in which the lock claw 814 engages the lock opening 411 and an unlocked state in which the lock claw 814 does not engage the lock opening 411. For example, when an external force is applied to the lock plate 812 from above and the lock plate 812 is brought close to the lock base 811, the lock claw 814 is lowered to be in the unlocked state. In this state, by fitting the second connector 3 to the first connector 2, placing the lock claw 814 under the lock opening 411, removing the external force to the lock plate 812, and allowing the lock plate 812 to elastically return in a direction away from the lock base 811, the lock claw 814 is placed in the lock opening 411. Accordingly, the lock claw 814 is engaged with the inner periphery of the lock opening 411, and the unlocked state is switched to the locked state. By again applying an external force to the lock plate 812 from above, bringing the lock plate 812 close to the lock base 811, and lowering the lock claw 814, the locked state is again switched to the unlocked state.

The lock knob 820 is an operation unit for simultaneously applying an external force for switching the locked state to the unlocked state to the lock plates 812 of the pair of lock portions 810. The lock knob 820 extends along the array orientation D21 to connect the lock plates 812 of the pair of lock portion 810 and overhangs rearward to span over the cable 10. By pushing down the lock knob 820 toward the plurality of cables 10, an external force from above is simultaneously applied to the lock plates 812 of the pair of lock portions 810, and the locked state may be switched to the unlocked state. The lock member 800 is formed by, for example, punching and bending a metallic thin plate.

Since the pair of lock accommodating portions 720 are provided at both ends of the outer housing 700 in the array orientation D21, the plurality of housings 520 are arranged between the pair of lock portions 810 when viewed from the front. By arranging the pair of lock portions 810 at positions that do not overlap the plurality of housings 520, both the reliability of the connection of the second connector 3 to the first connector 2 and the reduction in height of the connector system 1 are achieved.

### Assembly Procedure of Second Connector

An example assembly procedure of the second connector 3 is described. The procedure includes: fixing the connection portion R1 of the second region A2 of the cable 10 onto the base plate 512 so as to face the facing surface 511 and connecting the transmission conductor 14 of the cable 10 to the signal contact 530; positioning the shell 600 to surround the housing 520 about an axis along the fitting direction D22 with the transmission conductor 14 of the cable 10 connected to the signal contact 530; and fixing the shell 600 to the connector base 510.

The transmission conductor 14 of the plurality of cables 10 may be connected to the plurality of signal contacts 530 simultaneously. Alternatively, the plurality of shells 600 may be fixed to the plurality of connector bases 510 at the same time.

The assembly procedure of the second connector 3 may further include accommodating the plurality of shells 600 fixed the connector base 510 in an insulating the outer housing 700.

Further, fixing the shell 600 to the connector base 510 may include: soldering the shell 600 to the base plate 512 via the shell fixing hole 515; and soldering the outer conductor 12 in the connecting portion R1 of the cable 10 to the base plate 512 via the fixing hole 514. These soldering operations may be performed simultaneously.

Hereinafter, a detailed procedure will be described. First, the first region A1 and the second region A2 are formed at one end of the cable 10 as illustrated in FIGS. 2A, 2B, and 2C. In the first region A1, the transmission conductor 14 is exposed by removing the sheath 13 and the outer conductor 12, and removing the dielectrics 15 of the pair of electric wires 11.

The method for peeling one end of the cable 10 for forming the first region A1 and the second region A2 may be a method using a cutting blade or a method using a laser. When a laser is used for the second region A2, various shapes may readily be coped with.

On the other hand, in the second region A2, the sheath 13 in a predetermined region is removed to form the connecting portion R1 in which the outer conductor 12 is exposed. A region other than the connecting portion R1 in the second region A2 becomes the non-connecting portion R2. In this manner, the plurality of cables 10, which are processed so that the first region A1 in which the transmission conductors 14 of the pair of electric wires 11 are exposed and the second region A2 including the connecting portion R1 and the non-connecting portion R2 are arranged in order from the tip, are arranged on the base unit 500 so as to be arranged along the array orientation D21. At this time, each of the transmission conductors 14 of the plurality of cables 10 is brought into contact with a corresponding signal contact 530, and each of the connecting portions R1 (the outer conductors 12) of the plurality of cables 10 is exposed downward from the corresponding the fixing hole 514. In this state, each of the transmission conductors 14 is connected to the connecting portion 531 of the signal contact 530 by soldering or a solid-phase bonding method such as ultrasonic bonding.

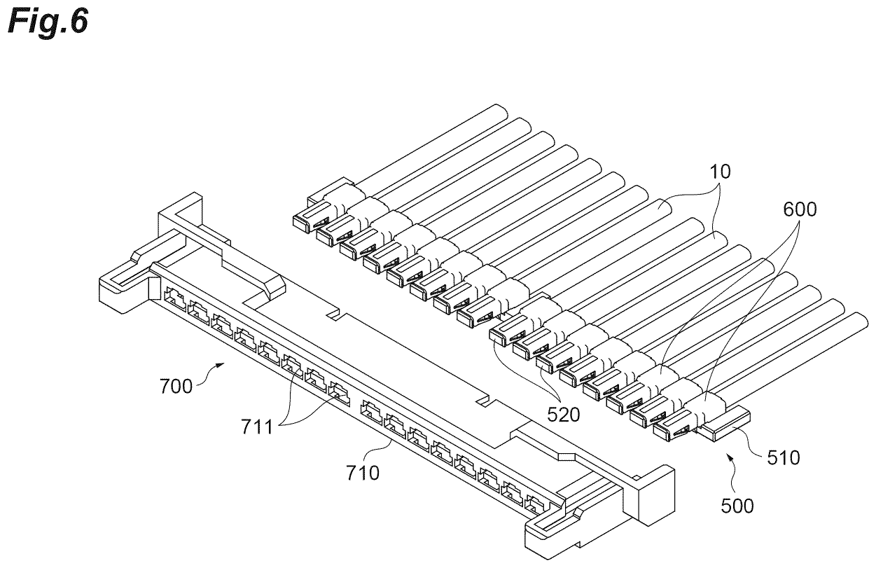

Next, as illustrated in FIG. 6, each of the plurality of shells 600 is placed so as to surround a corresponding housing 520. In this state, soldering through the plurality of shell fixing holes 515 and the plurality of fixing holes 514 is performed from the lower side of the base plate 512 to connect the outer conductor 12 to the base plate 512, and the plurality of cables 10 and the plurality of shells 600 are fixed to the base plate 512.

Next, the base unit 500 to which the plurality of shells 600 are fixed is inserted into the outer housing 700 from the rear, and the plurality of housings 520 are protruded forward from the plurality of openings 711, respectively. Next, as illustrated in FIG. 7, the separator 730 is molded by two color molding of resins. Finally, the lock member 800 is attached to the outer housing 700. Thus, the assembly of the second connector 3 is completed.

### Modifications of Cable

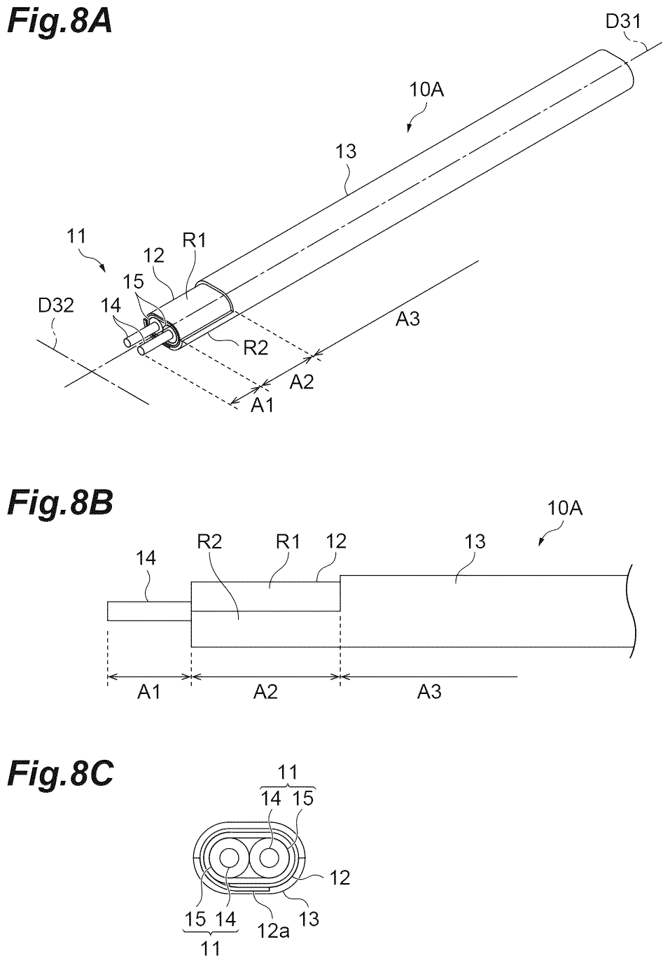

How to arrange the connecting portion R1 and the non-connecting portion R2 in the second region A2 of the cable may be modified. Hereinafter, two modifications of the cable and a state in which these cables are attached to the base unit 500 will be described with reference to FIGS. 8A, 8B, 8C, 9A, 9B, 10A, 10B, 10C, 11A, and 11B.

### First Modification

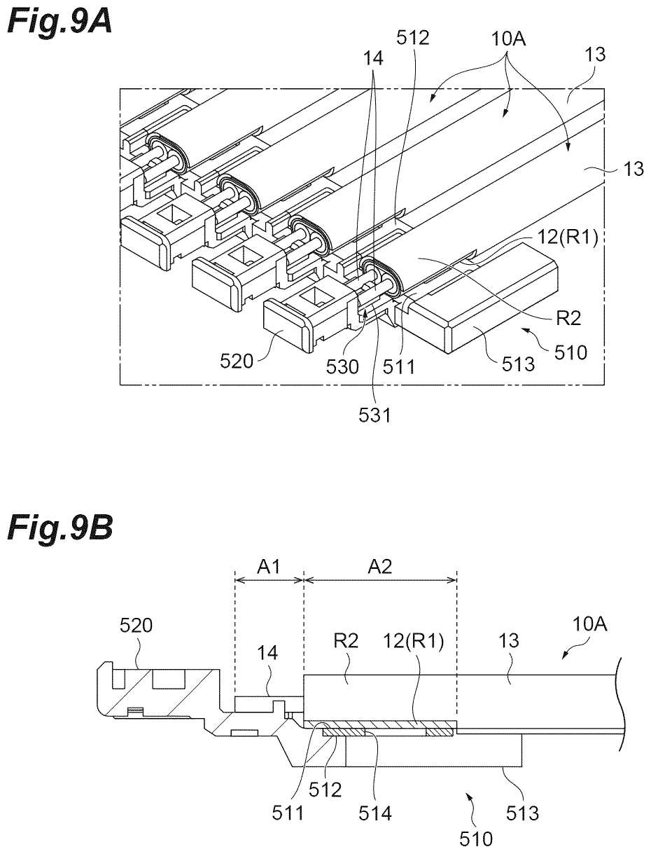

A cable 10A according to a first modification will be described with reference to FIGS. 8A, 8B, 8C, 9A, and 9B. FIGS. 8A and 8B are diagrams illustrating the cable 10A, and 9A and 9B are diagrams illustrating a state in which the cable 10A is attached to the base unit 500.

Compared to the cable 10, the cable 10A is the same in that the transmission conductor 14 is exposed in the first region A1, but is different in the arrangement of the connecting portion R1 and the non-connecting portion R2 in the second region A2.

In the cable 10A, each of the connecting portion R1 and the non-connecting portion R2 is adjacent to the first region A1. Further, each of the connecting portion R1 and the non-connecting portion R2 is adjacent to the third region A3. For example, the connecting portion R1 of the second region A2 extends from the boundary with the first region A1 to the inner end of the cable 10A and spreads throughout the second region A2 along the axial orientation D31. Further, as illustrated in FIGS. 8A and 8B, the connecting portion R1 is formed so as to spread on one surface (the upper surface in FIG. 8B) of the surfaces extending along the array orientation D32 of the pair of electric wires 11. The connecting portion R1 may also be provided on a side surface of the cable 10 (an end portion of the cable 10 in the array orientation D32). As illustrated in FIG. 8C, the connecting portion R1 is formed on the upper half of the ellipse as viewed from the D31 direction, but may not be formed on the upper half. The distance along the axial orientation D31 of the connecting portion R1 is equal to the second region A2.

The non-connecting portion R2 is formed in a region of the second region A2 where the connecting portion R1 is not provided. That is, the non-connecting portion R2 extends from the boundary with the first region A1 to the inner end of the cable 10A and spreads throughout the second region A2 along the axial orientation D31. Further, as illustrated in FIGS. 8A and 8B, the non-connecting portion R2 is also formed so as to spread on one surface (lower surface in FIG. 8B) of the surfaces extending along the array orientation D32 of the pair of electric wires 11. The length of the non-connecting portion R2 along the axial orientation D31 is also equal to that of the second region A2. At this time, as illustrated in FIG. 8C, in the second region A2, the overlapping portion 12a is covered by the sheath 13 constituting the non-connecting portion R2. Therefore, the movement of the overlapping portion 12a is restricted.

The lengths of the first region A1 and the second region A2 in the cable 10A are set based on their relationship with the second connector 3. The position and size of the connecting portion R1 may also be adjusted based on the relationship with the second connector 3.

A state in which the cable 10A is attached to the base unit 500 is illustrated in FIGS. 9A and 9B. FIGS. 9A and 9B are views in the same state as FIGS. 5A and 5B illustrating a state where the cable 10 is attached to the base unit 500.

A plurality of cables 10A are placed on the base unit 500 so as to line up along the array orientation D21. At this time, the connecting portion R1 of the cable 10A is placed on the base unit 500 so as to face the facing surface 511 of the base unit 500. In this state, each of the transmission conductors 14 of the plurality of cables 10A is brought into contact with a corresponding signal contact 530. The connecting portion R1 (the outer conductor 12) of each of the plurality of cables 10A is exposed downward from the corresponding the fixing hole 514. At this time, since the lower surface (the facing surface 511) of the cable 10A is the connecting portion R1 as a whole, that is, the outer conductor 12 is exposed, when the cable 10A is placed on the base unit 500, the base plate 512 and the outer conductor 12 come into contact with each other. In this state, the base plate 512 and the outer conductor 12 are connected via the fixing hole 514 by soldering or a solid-phase bonding method such as ultrasonic bonding, and the transmission conductor 14 of each of the connecting portions R1 is connected to the connecting portion 531 of the signal contact 530, whereby the transmission conductor 14 and the signal contact 530 are electrically connected. In FIG. 9B, the signal contact 530 is not illustrated because it is embedded in the housing 520.

As illustrated in FIG. 8B, in the cable 10A, since the sheath 13 is completely removed from one surface (here, the upper surface) of the surfaces of the pair of electric wires 11 extending along the array orientation D32, the height of the cable 10A in the second region (the distance between the surfaces formed along the array orientation D32 of the pair of electric wires 11: the vertical length illustrated in FIG. 8B) is smaller than the height of the cable 10A continuous from the second region A2 along the axial orientation, that is, the height of the region where the sheath 13 is not removed. When such a cable 10A is attached to the base unit 500, as illustrated in FIGS. 9A and 9B, a state where the base plate 512 is in contact with the outer conductor 12 of the connecting portion R1 as a whole is formed, so that the height of the joint structure (the vertical length illustrated in FIG. 9B) may be reduced by the thickness of the sheath 13 removed to form the connecting portion R1. Accordingly, the height of the second connector 3 assembled using the cable 10A may be reduced as compared with the second connector 3 assembled using the cable 10.

### Second Modification

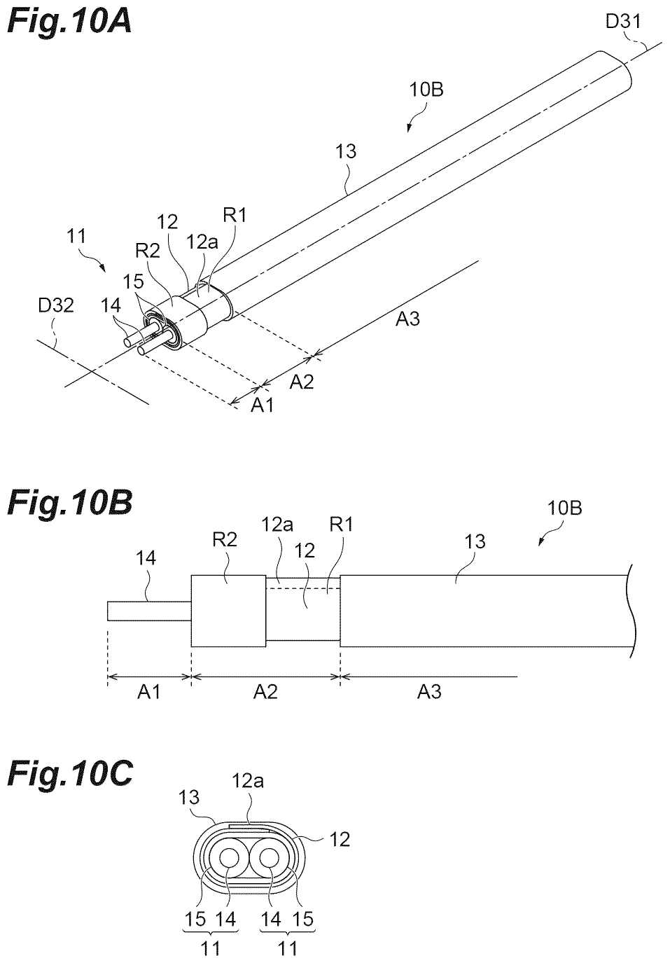

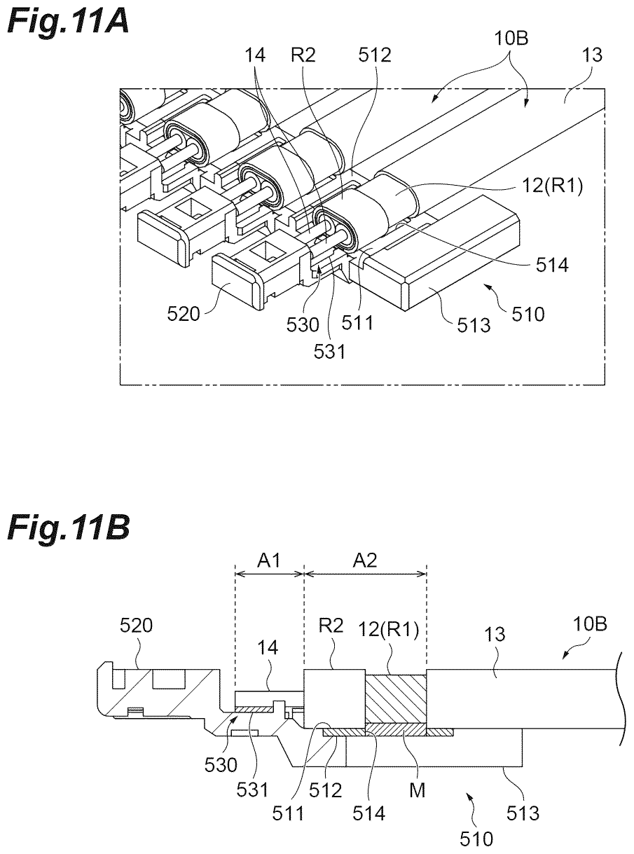

A cable 10B according to a second modification will be described with reference to FIGS. 10A, 10B, 10C, 11A, and 11B. FIGS. 10A, 10B, and 10C are diagrams illustrating the cable 10B, and FIGS. 11A and 11B are diagrams illustrating a state in which the cable 10B is attached to the base unit 500.

Compared to the cable 10, the cable 10B is the same in that the transmission conductor 14 is exposed in the first region A1, but is different in the arrangement of the connecting portion R1 and the non-connecting portion R2 in the second region A2.

In the cable 10B, the non-connecting portion R2 extends around the entire circumference of the cable 10. For example, the non-connecting portion R2 of the second region A2 has a shape similar to that of the annular portion R21 provided in the cable 10. That is, the non-connecting portion R2 is formed as an annular region that covers the entire circumference of the pair of electric wires 11 at the boundary with the first region A1. As illustrated in FIGS. 10A and 10B, the sheath 13 of the annular non-connecting portion R2 surrounds the outer conductor 12 of the cable 10B all around. Therefore, as illustrated in FIG. 10C, in the second region A2, a part of the overlapping portion 12a (a part close to the boundary between the first region A1 and the second region A2) is covered by the sheath 13. Accordingly, movement of the overlapping portion 12a is restricted in the vicinity of the boundary between the first region A1 and the second region A2.

The connecting portion R1 is formed in a region of the second region A2 where the non-connecting portion R2 is not provided. In particular, the connecting portion R1 is formed to be annular at the inner end of the cable 10B relative to the annular non-connecting portion R2. As described above, in the cable 10B, the annular non-connecting portion R2 and the connecting portion R1 are arranged in this order from the boundary with the first region A1 toward the back of the cable 10B (opposite to the tip). The lengths of the non-connecting portion R2 and the connecting portion R1 along the axial orientation D31 are set based on the relationship with the second connector 3.

A state in which the cable 10B is attached to the base unit 500 is illustrated in FIGS. 11A and 11B. FIGS. 11A and 11B are views in the same state as FIGS. 5A and 5B illustrating a state where the cable 10 is attached to the base unit 500.

A plurality of cables 10B are placed on the base unit 500 so as to line up along the array orientation D21. At this time, the connecting portion R1 of the cable 10B is placed on the base unit 500 so as to face the facing surface 511 of the base unit 500. In this state, each of the transmission conductors 14 of the plurality of cables 10B is brought into contact with a corresponding signal contact 530. The connecting portion R1 (the outer conductor 12) of each of the plurality of cables 10B is exposed downward from the corresponding the fixing hole 514. In this state, the base plate 512 and the outer conductor 12 are connected via the fixing hole 514 by soldering or a solid-phase bonding method such as ultrasonic bonding, and the transmission conductor 14 of each of the connecting portions R1 is connected to the connecting portion 531 of the signal contact 530, whereby the transmission conductor 14 and the signal contact 530 are electrically connected. In FIG. 11B, a state in which the base plate 512 and the outer conductor 12 are fixed by the solder M after melting and are electrically connected is illustrated.

As described above, the cable 10, 10A, 10B includes the pair of transmission conductors 14 having conductivity, the dielectric 15 covering the pair of transmission conductor 14, the outer conductor 12 covering a surface of the dielectric 15, and the sheath 13 covering a surface of the outer conductor 12. In the first region A1 that is a range of a first length from the tip of the cable 10, the sheath 13, the outer conductor 12 and the dielectric 15 are removed and the transmission conductor 14 is exposed. Further, in the inner end of the cable 10 with respect to the first region A1, the second region A2, which is a range of second length continuous with the first region A1, includes the connecting portion R1 from which the sheath 13 is removed and the outer conductor 12 is exposed, and the non-connecting portion R2 covered with the sheath 13.

In the above configuration, the non-connecting portion R2 has a structure in which the outer conductor 12 is covered with the sheath 13. Therefore, deformation of the outer conductor 12 is prevented as compared with a cable that does not have the non-connecting portion R2. Therefore, according to the cable described above, a degradation of transmission quality is prevented. When a connector and a cable are joined, the sheath 13 is removed to expose the outer conductor 12 in a region continuous from the first region A1 in which the transmission conductor 14 is exposed, thereby connecting the outer conductor 12 and the ground conductor of the connector. When the sheath 13 is removed, an external force acts on the outer conductor 12 inside the sheath 13, and there is a possibility that the outer conductor 12 is deformed. The deformation of the outer conductor 12 may affect the deterioration of the transfer characteristics. On the other hand, in the above-described cable 10, since there is the non-connecting portion R2 covered by the sheath 13 in the second region A2, deformation of the outer conductor 12 may be prevented.

In the second region A2, the boundary with the first region A1 may be the non-connecting portion R2. As an example, the entire circumference of the boundary with the first region A1 may be the non-connecting portion R2. Since the outer conductor 12 is covered by the sheath 13 constituting the non-connecting portion R2 at the boundary with the first region A1, deformation of the outer conductor 12 is prevented.

The non-connecting portion R2 may include: the annular portion R21 that covers the entire circumference of the cable 10 at the boundary with the first region A1; and the coupling portion R22 that extends from the annular portion R21 along the axial orientation D31 of the cable 10 and is continuous with the sheath 13 provided at the inner end of the second region A2. A structure in which the outer conductor 12 is covered with the sheath 13 of the non-connecting portion R2 is formed in the annular portion R21. Further, since the outer conductor 12 is covered by the sheath 13 also in the coupling portion R22 continuous with the sheath, deformation of the outer conductor 12 is further prevented.

The connecting portion R1 and the non-connecting portion R2 may be respectively provided to extend continuously from the boundary with the first region A1 along the axial orientation D31 of the cable 10. Since the non-connecting portion R2 continuously extending from the boundary of the first region A1 has a structure in which the outer conductor 12 is covered with the sheath 13 of the non-connecting portion R2, deformation of the outer conductor 12 is prevented.

The connecting portion R1 may be provided along a surface extending along the array orientation D32 of the pair of transmission conductors 14. Since the sheath 13 is removed from a surface extending along the array orientation D32 of the pair of transmission conductors 14, the height of the cable 10 in the second region A2 may be reduced. Accordingly, even when the cable 10 is connected to the connector (the second connector 3), a height as a joint structure may be reduced.

The outer conductor 12 may be formed by wrapping a plate-like member extending along the axial orientation D31 of the cable 10 around the dielectric 15, and may include the overlapping portion 12a where the ends of the plate-like member overlap. At least a part of the overlapping portion 12a included in the second region A2 may be the non-connecting portion R2, that is, covered by the sheath 13. When the outer conductor 12 is formed by wrapping a plate-like member extending along the axial orientation D31 of the cable 10 around the pair of electric wires 11 including the dielectrics 15, deformation of the outer conductor 12 may occur from the overlapping portion 12a where the ends overlap. That is, the deformation of the outer conductor 12 may progress due to loosening of the winding of the plate-like member from the overlapping portion 12a. On the other hand, by using a configuration in which a part of the overlapping portion 12a is the non-connecting portion R2 in the second region A2 and the sheath 13 covers the overlapping portion 12a, deformation of the outer conductor 12 is prevented.

In a joint structure of a plurality of cables according to the present disclosure, the cable 10 includes: the pair of transmission conductors 14 having conductivity; the dielectric 15 covering the pair of transmission conductors; the outer conductor 12 covering a surface of the dielectric; and the sheath 13 covering a surface of the outer conductor. In addition, the sheath 13, the outer conductor 12, and the dielectric 15 are removed and transmission conductors are exposed in the first region A1 that is within a range of a first length from the tip of the cable 10. The second region A2, which is a range of second length continuous with the first region A1 at the inner end of the cable 10 relative to the first region A1, includes the connecting portion R1 from which the sheath 13 is removed and the outer conductor 12 is exposed, and the non-connecting portion R2 covered by the sheath 13. Further, the joint structure further includes the base plate 512 as a conductive ground bar including a plurality of facing surfaces individually facing the connecting portion R1 in each of the plurality of cables 10, wherein the connecting portion R1 in each of the plurality of cables 10 and the plurality of facing surfaces in the ground bar are electrically connected.

In the joint structure of the plurality of cables 10 described above, in the non-connecting portion R2 of the cable 10, since the outer conductor 12 is covered with the sheath 13, the deformation of the outer conductor is prevented compared to a cable that does not have the non-connecting portion R2. Accordingly, with the joint structure using the above-described the cable 10, a degradation of transfer quality is prevented.

The ground bar may be integrated with the insulating base housing 513.

In a joint structure of a plurality of cables and a connector according the present disclosure, the cable 10 includes: the pair of transmission conductors 14 having conductivity; the dielectric 15 covering the pair of transmission conductors; the outer conductor 12 covering a surface of the dielectric; and the sheath 13 covering a surface of the outer conductor. In addition, the sheath 13, the outer conductor 12, and the dielectric 15 are removed and transmission conductors are exposed in the first region A1 that is within a range of a first length from the tip of the cable 10. The second region A2, which is a range of second length continuous with the first region A1 at the inner end of the cable 10 relative to the first region A1, includes the connecting portion R1 from which the sheath 13 is removed and the outer conductor 12 exposed, and the non-connecting portion R2 covered by the sheath 13. The second connector 3 as the connector includes: the base plate 512 as a conductive ground bar having a plurality of facing surfaces individually facing the connecting portion R1 in each of the plurality of cables 10; the insulating base housing 513 integrated with the ground bar; and the signal contact 530 as a plurality of pairs of contacts fixed to the base housing 513. At this time, the connecting portion R1 of each of the plurality of cables and the facing surfaces of the ground bar are electrically connected, and the contact and the corresponding transmission conductor 14 are electrically connected.

According to the joint structure of the plurality of cables and the connector described above, since the non-connecting portion R2 of the cable 10 has a structure in which the outer conductor 12 is covered with the sheath 13, deformation of the outer conductor is suppressed compared to a cable that does not have the non-connecting portion R2. Therefore, according to the joint structure using the cable, a degradation of the transmission quality is suppressed.

The joint structure may further include the conductive shell 600 provided so as to surround an outer periphery of the cable 10 and fixed to the base housing 513.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A cable assembly comprising a cable and a connector, wherein the cable comprises:
a pair of transmission conductors having conductivity;
a dielectric covering the pair of transmission conductors;
an outer conductor covering a surface of the dielectric; and
a sheath covering the outer conductor,
wherein the cable comprises a first region, a second region, and a third region sequentially aligned from a tip of the cable,
wherein in the first region, the sheath, the outer conductor, and the dielectric are removed and the pair of transmission conductors are exposed,
wherein the second region comprises:
a connecting portion in which the sheath is removed and the outer conductor is exposed; and
a non-connecting portion covered by the sheath,
wherein in the third region, the outer conductor is covered with the sheath entirely over a circumference of the cable,
wherein the connector comprises:
a pair of conductive contacts electrically connected to the pair of transmission conductors; and
a conductive shell surrounding the pair of conductive contacts and electrically connected to the connecting portion.

2. The cable assembly according to claim 1, wherein the connecting portion is adjacent to the third region.

3. The cable assembly according to claim 1, wherein the non-connecting portion is adjacent to the first region.

4. The cable assembly according to claim 3, wherein the connecting portion is adjacent to at least a part of the non-connecting portion along the circumference.

5. The cable assembly according to claim 4, wherein the non-connecting portion comprises:
an annular portion adjacent to the first region and extending entirely over the circumference; and
a coupling portion coupling the annular portion to the third region, and
wherein the connecting portion is adjacent to the coupling portion along the circumference.

6. The cable assembly according to claim 4, wherein each of the connecting portion and the non-connecting portion is adjacent to the first region.

7. The cable assembly according to claim 6, wherein the connecting portion extends along an array orientation of the pair of transmission conductors.

8. The cable assembly according to claim 1, wherein the outer conductor is formed by winding a plate-like member extending along an axial orientation of the cable around the dielectric,
wherein the outer conductor comprises an overlapping portion at which ends of the plate-like member overlap each other, and
wherein at least a part of the overlapping portion is covered with the sheath of the non-connecting portion in the second region.

9. The cable assembly according to claim 1 comprising a plurality of cables including the cable, each of the plurality of cables comprising the pair of transmission conductors, the dielectric, the outer conductor, the sheath, the first region, the second region, and the third region,
wherein the connector comprises:
a plurality of pairs of conductive contacts including the pair of conductive contacts, wherein the plurality of pairs of conductive contacts correspond to the plurality of cables; and
a plurality of conductive shells including the conductive shell, wherein the plurality of conductive shells correspond to the plurality of cables,
wherein each of the plurality of conductive shells surrounds a corresponding pair of conductive contacts and connected to the connecting portion of a corresponding cable.

10. The cable assembly according to claim 9, wherein the plurality of cables are arranged along an array orientation crossing the pair of transmission conductors,
wherein the connecting portion of each of the plurality of cables is aligned with the connecting portion of an adjacent cable along the array orientation,
wherein the connector comprises a conductive ground bar extending along the array orientation and electrically connected to the connecting portion of each of the plurality of cables, and
wherein each of the plurality of conductive shells is electrically connected to the ground bar.

11. The cable assembly according to claim 10, wherein the connector comprises:
an insulating base housing integrated with the conductive ground bar; and
a plurality of insulating sub housings that correspond to the plurality of cables,
wherein each of the plurality of insulating sub housings holds a corresponding pair of conductive contacts and is fixed to the insulating base housing, and
wherein each of the plurality of conductive shells surrounds a corresponding insulating sub housing.

12. A cable comprising:
a pair of transmission conductors having conductivity;
a dielectric covering the pair of transmission conductors;
an outer conductor covering a surface of the dielectric; and
a sheath covering the outer conductor,
wherein the cable comprises a first region, a second region, and a third region sequentially aligned from a tip of the cable,
wherein in the first region, the sheath, the outer conductor, and the dielectric are removed and the pair of transmission conductors are exposed,
wherein the second region comprises:
a connecting portion in which the sheath is removed and the outer conductor is exposed; and
a non-connecting portion covered by the sheath,
wherein in the third region, the outer conductor is covered with the sheath entirely over a circumference of the cable.

13. The cable according to claim 12, wherein the connecting portion is adjacent to the third region.

14. The cable according to claim 12, wherein the non-connecting portion is adjacent to the first region.

15. The cable according to claim 14, wherein the connecting portion is adjacent to at least a part of the non-connecting portion along the circumference.

16. The cable according to claim 15, wherein the non-connecting portion comprises:
an annular portion adjacent to the first region and extending entirely over the circumference; and
a coupling portion coupling the annular portion to the third region, and
wherein the connecting portion is adjacent to the coupling portion along the circumference.

17. The cable according to claim 15, wherein each of the connecting portion and the non-connecting portion is adjacent to the first region.

18. The cable according to claim 17, wherein the connecting portion extends along an array orientation of the pair of transmission conductors.

19. The cable according to claim 12, wherein the outer conductor is formed by winding a plate-like member extending along an axial orientation of the cable around the dielectric,
wherein the outer conductor comprises an overlapping portion at which ends of the plate-like member overlap each other, and
wherein at least a part of the overlapping portion is covered with the sheath of the non-connecting portion in the second region.

20. A cable assembly comprising:
a plurality of cables including the cable according to claim 12, each of the plurality of cables comprising the pair of transmission conductors, the dielectric, the outer conductor, the sheath, the first region, the second region, and the third region; and
a conductive ground bar,
wherein the plurality of cables are arranged along an array orientation crossing the pair of transmission conductors,
wherein the connecting portion of each of the plurality of cables is aligned with the connecting portion of an adjacent cable along the array orientation, and
wherein the conductive ground bar extends along the array orientation and electrically connected to the connecting portion of each of the plurality of cables.
